(19) United States
(12) Patent Application Publication
(10) Pub. No.: US 2024/0251380 A1
(43) Pub. Date: Jul. 25, 2024

(54) COMMUNICATION SYSTEM, COMMUNICATION METHOD AND POSITIONING DEVICE FOR FREQUENCY MANAGEMENT SYSTEM

(71) Applicant: WISTRON NEWEB CORPORATION, HSINCHU (TW)

(72) Inventors: Michael John Talbert, HSINCHU (TW); KUO-CHAO YEN, HSINCHU (TW); KUANG-CHUN LIU, HSINCHU (TW)

(21) Appl. No.: 18/415,704

(22) Filed: Jan. 18, 2024

Related U.S. Application Data
(60) Provisional application No. 63/480,541, filed on Jan. 19, 2023.

(51) Int. Cl. H04W 64/00; G01S 5/14; G01S 19/42

(52) U.S. Cl. CPC H04W 64/006; G01S 5/14; G01S 19/42

(57) ABSTRACT

A communication system, a communication method and a positioning device for a frequency management system are provided. The communication system includes at least one positioning device and one or more network devices. The at least one positioning device is configured to generate and broadcast location information. The one or more network devices are configured to receive the location information. The one or more network devices are configured to perform a frequency communication process with the frequency management system by using the received location information as current location information of the one or more network devices.

### CROSS-REFERENCE TO RELATED PATENT APPLICATION

This application claims the benefit of priority to the U.S. Provisional Patent Application Ser. No. 63/480,541, filed on Jan. 19, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system, a method and a device, and more particularly to a communication system, a communication method and a positioning device for a frequency management system.

### BACKGROUND OF THE DISCLOSURE

The Federal Communications Commission (FCC) has established two categories of devices to prevent interference with existing 6 GHz users, which are low power access points (APs) and standard power APs. The low power APs are designed for indoor Wi-Fi use and operate at lower power levels, it is unlikely for the low power APs to interfere with existing 6 GHz users. For example, current service providers based in North America are utilizing WI-FI 6E for backhaul connection between routers and extenders. Unfortunately, current designs are based upon low power which does not have the ability to propagate across the home environment due to FCC requirements mandating low power for usage in the home.

To move from the low power to higher power applications, the standard power APs are designed for both indoor and outdoor Wi-Fi use and operate at higher power levels and therefore have a greater potential to interfere with existing 6 GHz users.

To prevent the standard power APs from disrupting current services, the FCC further implements a system to coordinate spectrum use and avoid interference issues, which is known as the automated frequency coordination (AFC) system capable of ensuring that standard power APs do not interfere with existing 6 GHz users.

To comply with the AFC system, network routers and extenders within a subscriber's network are required to utilize global positioning system (GPS) technology to ascertain their geographical coordinates prior to initiating a request to the AFC system.

However, the efficacy of GPS technology is significantly diminished within indoor environments, necessitating GPS capabilities for all of routers or extenders within the subscriber's residence. This approach is not only cumbersome but also aesthetically unappealing due to the requirement of a cable connection running from the router or extender to a GPS antenna.

### SUMMARY OF THE DISCLOSURE

In response to the above-referenced technical inadequacies, the present disclosure provides a communication system, a communication method and a positioning device for a frequency management system.

In order to solve the above-mentioned problems, one of the technical aspects adopted by the present disclosure is to provide a communication system for a frequency management system, the communication system includes at least one positioning device and one or more network devices. The at least one positioning device is configured to generate and broadcast location information. The one or more network devices are configured to receive the location information. The one or more network devices are configured to perform a frequency communication process with the frequency management system by using the received location information as current location information of the one or more network devices.

In order to solve the above-mentioned problems, another one of the technical aspects adopted by the present disclosure is to provide a communication method for a frequency management system. The communication method includes: generating and broadcasting location information by at least one positioning device; and receiving the location information and performing, by one or more network device, a frequency communication process with the frequency management system using the received location information as current location information of the one or more network devices.

In order to solve the above-mentioned problems, yet another one of the technical aspects adopted by the present disclosure is to provide a positioning device for a frequency management system. The positioning device communicatively connects to a communication system that includes one or more network devices, and the positioning device includes a processing circuit, a positioning module and a short-range wireless communication circuit. The positioning module is configured to obtain location information. The short-range wireless communication circuit is controlled by the processing circuit for connecting to the one or more network devices, so as to broadcast the location information to the one or more network devices. The location information received by the one or more network devices are used to perform a frequency communication process with the frequency management system.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a communication system according to one embodiment of the present disclosure;

FIG. 2 is a first schematic diagram of the positioning device according to one embodiment of the present disclosure;

FIG. 3 is a flowchart of a communication method for the frequency management system according to one embodiment of the present disclosure; and

FIG. 4 is an exemplary implementation of the communication system according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

An object of the present disclosure is to provide a practical application of GPS solution for standard/high power utilizations of 6 Ghz Wi-Fi 6E, and more particularly, to facilitate applications for the use of a “GPS Locater” that could be wirelessly connected to network devices such as router/extender/repeater/mesh endpoint via the use of Bluetooth® low energy (BLE) technology.

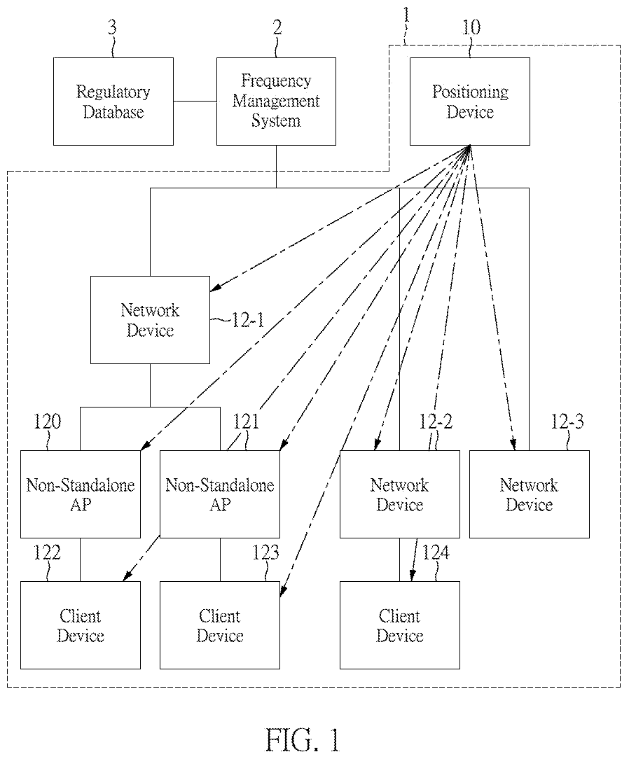

FIG. 1 is a functional block diagram of a communication system according to one embodiment of the present disclosure. Referring to FIG. 1, a first embodiment of the present disclosure provides a communication system 1 for a frequency management system 2. For example, the frequency management system 2 can be an automated frequency coordination (AFC) system based on FCC requirements. The communication system 1 can include a positioning device 10 and network devices 12-1, 12-2 and 12-3. However, quantities of the positioning device 10 and the network devices 12-1, 12-2 and 12-3 are not limited to the embodiment shown in FIG. 1.

Each of the network devices 12-1, 12-2 and 12-3 can be, for example, an access point (AP), a gateway, a router, an extender, a repeater, a mesh device, a RLAN (radio local area network) device, a WLAN (wireless local area network), or any other device configured to perform wireless communications with other devices. The network devices 12-1, 12-2 and 12-3 are connected to the frequency management system 2, in which communications between each of the network devices 12-1, 12-2 and 12-3 and the frequency management system 2 can be over wired or wireless links not in the 6 GHz band. Furthermore, each of the network devices 12-1, 12-2 and 12-3 can be connected to one or more other network devices, such as non-standalone APs and client devices. For example, the network device 12-1 can be connected to non-standalone APs 120, 121, and the non-standalone APs 120 and 121 and the network device 12-2 are connected to client device 122, 123 and 124, respectively. In the present embodiment, the network devices shown in FIG. 1 are AFC-capable devices, and each of which is capable of performing a frequency communication process (e.g., AFC communication process) with the frequency management system 2. However, the aforementioned details are disclosed for exemplary purposes only, and are not meant to limit the scope of the present disclosure.

The frequency management system 2 is a key component in managing the use of the 6 GHz band for Wi-Fi operations. The frequency management system 2 is designed to protect incumbent users of the band while enabling higher Wi-Fi power levels to be used in access points both indoors and outdoors. The frequency management system 2 can be connected to a regulatory database 3 that contains information about nearby incumbent operations, such as location-specific parameters of the incumbent operations. The frequency management system 2 may use the information to calculate the potential of interference occurring across different frequencies. The regulatory database 3 also supports regulatory messaging, including registration parameters, available spectrum inquiry request and response messages, which facilitate regulatory compliance of the frequency management system 2 (i.e., AFC system) and the network devices 12-1, 12-2 and 12-3 (i.e., AFC devices).

Each of the network devices 12-1, 12-2 and 12-3 can perform the frequency communication process with the frequency management system 2. In the present embodiment, the frequency communication process can be the AFC communication process that typically includes steps of device registration, frequency request and response, device operation and periodic updates. It should be noted that communications (e.g., queries, responses and data exchanges) between each of the network devices 12-1, 12-2 and 12-3 and the frequency management system 2 during these steps should be made outside of the 6 GHz bands.

In the step of device registration, at least one of the network devices 12-1, 12-2 and 12-3 and the other network devices (i.e., AFC devices) can register with the frequency management system 2 (i.e. AFC system), providing necessary information such as a geographic location thereof.

In the step of frequency request and response, the at least one of the network devices 12-1, 12-2 and 12-3 and the other network devices sends a request to the frequency management system 2 for a list of available frequencies for operation at the geographic location thereof, then the frequency management system 2 checks the regulatory database 3, which includes information associated with the incumbent users of the 6 GHz band, then returns a list of available frequencies that the at least one of the network devices 12-1, 12-2 and 12-3 and the other network devices can use without causing interference to these incumbent users.

After the at least one of the network devices 12-1, 12-2 and 12-3 and the other network devices, which can also be referred to as an AFC device in this embodiment, receives the list of the available frequencies, the AFC device begins operation on an available frequency from the list provided by the frequency management system 2 in the step of device operation. In the meantime, the AFC device may further periodically check in with the frequency management system 2 to update the frequency list in the step of periodic updates, ensuring that the AFC device can continue to avoid causing interference to the incumbent users.

It should be noted that the flow of the frequency communication process mentioned above is merely a simplified view, and actual implementations thereof can include additional steps or variations based on specific requirements or standards.

However, the requirement to use positioning technique (e.g., GPS) with the frequency management system 2 for the network devices (e.g., 12-1, 12-2 and 12-3) presents a significant issue as GPS is not effective within a building in the majority of installations. For GPS to be implemented in home routers/extenders/repeaters/mesh devices, it would mandate the inclusion of a GPS antenna which although is possible, does not provide a solution that would be acceptable to most home or small business owners. The network device is often equipped with an external GPS antenna which could be tethered to each of the devices. More specifically, such installation of the GPS antenna would be cumbersome and inconvenient for end users, and such inefficiency may lead to a high rate of failed installations, and ultimately poor customer experience and high churn rate.

Therefore, at least one of the positioning device 10 can be provided. The communication system 1 can be established in a target area, such as an indoor space of a building or a house, and the positioning device 10 can be centrally located near a window and serve the customer's network infrastructure to identify the locations of the network devices within the house.

The positioning device 10 can be configured to obtain a location that will be used with the frequency management system 2 to ensure that the existing 6 Ghz services within the target area are not adversely affected. The positioning device 10 can be, for example, a GPS locater that is wirelessly connected to the network devices 12-1, 12-2 and 12-3 and the other network devices (i.e., the non-standalone APs 120 and 121 and the client device 122, 123 and 124). However, other positioning technology can be utilized, the aforementioned details are disclosed for exemplary purposes only, and are not meant to limit the scope of the present disclosure.

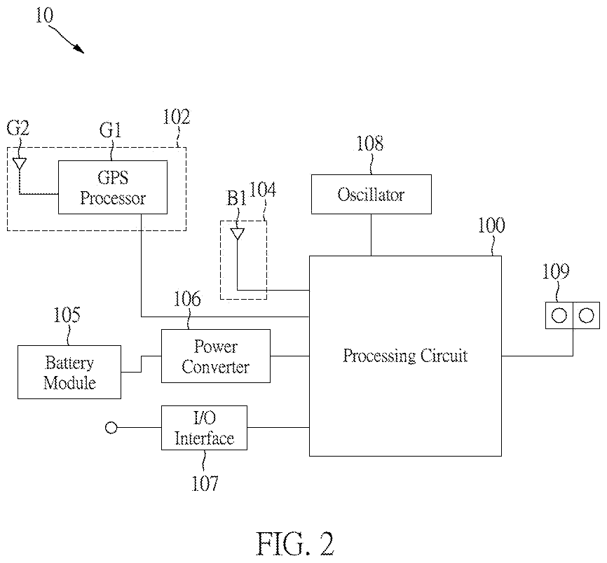

FIG. 2 is a first schematic diagram of the positioning device according to one embodiment of the present disclosure. Referring to FIG. 2, the positioning device 10 includes a processing circuit 100, a positioning module 102 and a short-range wireless communication circuit 104.

The positioning module 102 can be a global positioning system (GPS) module that include a GPS processor G1 and a GPS antenna G2 connected to the GPS processor G1. The GPS antenna G2 can be used by the GPS processor G1 to receive signals from GPS satellites, and the GPS processor G1 calculates or obtains a precise location of the positioning device 10. The obtained precise location can serve as location information, which includes, for example, latitude information, longitude information and altitude information.

The processing circuit 100 can be, for example, a processor or a microcontroller unit. The processing circuit 100 can process data acquired from the positioning module 102, and can also handle communications with other devices through the short-range wireless communication circuit 104.

Specifically, the altitude information can be obtained in various manners. For example, the processing circuit 100 or the GPS processor G1 can be configured to obtain the altitude information from the GPS signal itself, in which computations of satellite signals, time delays, distances trilateration are involved. Alternatively, the positioning device 10 can include an altimeter for obtaining the altitude information according to air pressure. However, the aforementioned details are disclosed for exemplary purposes only, and are not meant to limit the scope of the present disclosure.

Furthermore, the short-range wireless communication circuit 104 can be controlled by the processing circuit 100 for connecting to the network devices 12-1, 12-2 and 12-3, the non-standalone APs 120 and 121 and the client device 122, 123 and 124, so as to broadcast the location information. The short-range wireless communication circuit 104 can be, for example, a Bluetooth® communication circuit that utilizes Bluetooth® technology for communication with the network devices 12-1, 12-2 and 12-3, the non-standalone APs 120 and 121 and the client device 122, 123 and 124. In general, the short-range wireless communication circuit 104 should have a sufficient range to cover a typical home in the U.S. home that is of average size. In certain cases of large-sized homes, more than one positioning device 10 can be utilized.

The short-range wireless communication circuit 104 can be implemented in various manners. In a built-in scenario, a Bluetooth® antenna B1 can be connected to and controlled by the processing circuit 100 so as to achieve short-range wireless communications via Bluetooth® technology. Alternatively, a standalone Bluetooth® low energy (BLE) module having a Bluetooth® antenna can be additionally provided to be connected to and used by the processing circuit 100. It should be noted that data transmissions of the location information between the positioning device 10 and each of the network devices can be performed without pairing with each other, thereby reducing complexity for system installation. However, other short-range wireless communication technology can be used, the aforementioned details are disclosed for exemplary purposes only, and are not meant to limit the scope of the present disclosure.

Moreover, the positioning device 10 further includes a battery module 105, a power converter 106, a I/O interface 107, an oscillator 108 and a light indicator 109. The battery module 105 and the power converter 106 can be configured to supply power for all components of the positioning device 10, and the power converter 106 can be, for example, a buck converter, a boost converter, or a buck-boost converter. The battery module 105 can include one or more changeable or chargeable batteries, such as lithium-ion batteries. The I/O interface 107 can be a communication interface designed for data transmissions between different electronic architectures, such as a universal serial bus (USB) to universal asynchronous receiver/transmitter (UART) interface, and the components of the positioning device 10 can be powered via the I/O interface 107.

The oscillator 108 (e.g., a crystal oscillator) in the positioning device 10 serves a critical role in maintaining accurate timekeeping, signal processing and ensuring overall system stability. For example, clock signals generated by the oscillator 108 can assist in converting high-frequency signals received from GPS satellites into lower frequencies that can be more easily processed. In certain embodiments, both the processing circuit 100 and the short-range wireless communication circuit 102 can be provided with oscillators.

The light indicator 109 can be controlled by the processing circuit 100 and used to show an operation state of the positioning device 10, such as a working state or a low power alarm thereof.

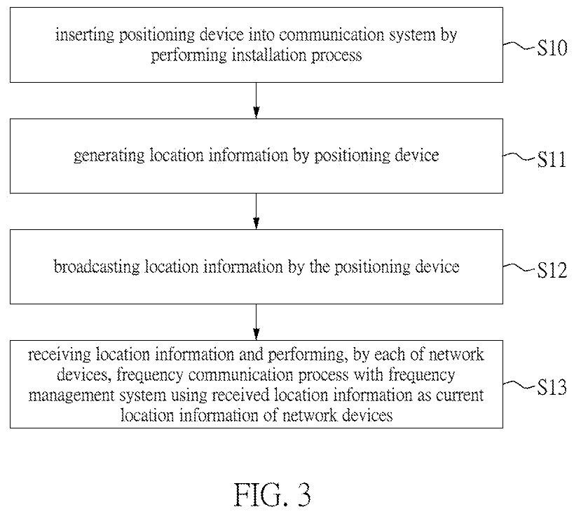

FIG. 3 is a flowchart of a communication method for the frequency management system according to one embodiment of the present disclosure.

Referring to FIG. 3, the present disclosure provides a communication method, which is suitable for the communication system 1 shown in FIG. 1. The communication method includes the following steps:
Step S10: inserting the positioning device into a communication system by performing an installation process.

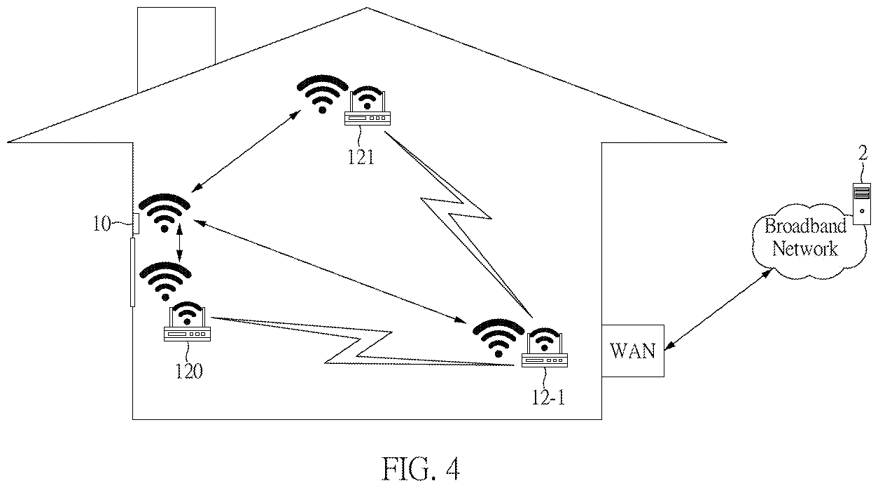

FIG. 4 is an exemplary implementation of the communication system according to one embodiment of the present disclosure.

Referring to FIG. 4, when the positioning device 10 is inserted into the communication system shown in FIG. 1, the installation process should be performed to ensure that the network devices, including the network device 12-1 and non-standalone APs 120 and 121, can obtain detailed location information from the positioning device 10, such that precise locations can be reported to the frequency management system 2 without changing the conventional AFC communication process, to be in consistent compliance with the Wi-Fi Alliance's test plan.

Since the positioning device 10 can broadcast its coordinate information over short-range communication technique, such as Bluetooth®, the location information reported by the network device 12-1 and non-standalone APs 120 and 121 are reasonably within the GPS accuracy defined within the FCC's rules.

During the installation process, the positioning device 10 can be arranged at a position where satellite's GPS signals can be received, such as near a window of a building shown in FIG. 4. Through the positioning device 10 being wirelessly connected to a user's home local area network (LAN) infrastructure, the utilization of standard or high power can be enabled, thereby facilitating an establishment of a backhaul mesh system with extremely high quality and low latency.

Furthermore, the positioning device 10 can be provided with an installation mode, in which the positioning device 10 can broadcast the location information quickly for confirming that each of the network device 12-1 and non-standalone APs 120 and 121 can receive the location information properly. For example, in response to the installation mode being triggered, the positioning device 10 can broadcast the location information within a relatively short time interval, so as to assist in speeding up the installation process.

Once any of the network device 12-1 and non-standalone APs 120 and 121 is not able to receive the location information from the positioning device 10, one or more positioning devices should be provided and arranged at proper positions for better coverage. However, to comply with FCC requirements, the positioning device 10 should be arranged within about 30 feet of the network device that is targeted to use standard power or high power.
Step S11: generating location information by the positioning device.

In step S11, the processing circuit 100 of the positioning device 10 shown in FIG. 2 can be configured to acquire the location information from the positioning module 102 repeatedly.
Step S12: broadcasting location information by the positioning device.

For example, the processing circuit 100 can control the short-range wireless communication circuit 104 to periodically broadcast the location information to all of the network devices within the target area of the communication system 1 according to a predetermined time interval. It should be noted that the predetermined time interval for periodically broadcasting the location information is longer than the short time interval used in the installation mode.

In some embodiments, a unique identifier can be further utilized to validate the Wi-Fi 6E devices in the frequency communication process when the positioning device 10 broadcasts its location information. Therefore, the positioning device 10 can be further configured to broadcast the unique identifier along with the location information in step S12. Furthermore, the processing circuit 10 can further encrypt the location information before the location information is broadcasted.
Step S13: receiving the location information and performing, by each of the network devices, the frequency communication process with the frequency management system using the received location information as current location information of the network devices.

In step S13, each of the network devices can take the received location information as current location information to perform the steps of the frequency communication process, including the steps of device registration, frequency request and response, device operation and periodic updates mentioned above. Particularly, in the step of device registration, the AFC device (i.e., the network devices 12-1, 12-2 and 12-3 and the other network devices) can register with the frequency management system 2 and provide the location information received from the positioning device 10. In addition, if the location information is encrypted by the processing circuit 10, each of the network devices 12-1, 12-2 and 12-3 can further decrypt the location information once received, so as to provide a security mechanism for data transmission.

In other embodiments, the obtained precise location is refined before serving as location information, or the location information is refined before serving as the current location information. In other words, at least one of the latitude information, the longitude information, and the altitude information is refined to improve the location accuracy of the network devices before being used in the frequency communication process.

Each of the network devices provided in the present disclosure should be able to communicatively connect to the positioning device 10; therefore, corresponding processor(s), a memory, a short-range wireless communication circuit, functionality network components should be included in each of the network devices.

Moreover, a data model, such as TR-181 data model, that describes various aspects (such as device management, security, compatibility, and spectrum management) of software operated on each of the network devices should be modified to establish a standardized definition to support and surveil the positioning device 10.

Therefore, objects such as the unique identifier, the latitude information, the longitude information, the altitude information, time of last update of the location information and the AFC system, and AFC results, should be added to the TR-181 data model, thereby properly managing and controlling broadband network devices and ensuring their compatibility with the communication system and the communication method provided by the present disclosure. However, the aforementioned details are disclosed for exemplary purposes only, and are not meant to limit the scope of the present disclosure.

### Beneficial Effects of the Embodiments

In conclusion, the communication system, method, and positioning device for the frequency management system, as disclosed, provide a practical application of GPS technology to address the standard/high power utilization of 6 GHz Wi-Fi 6E, which is achieved by employing a specially designed positioning device that can be wirelessly tethered to network devices such as routers, extenders, repeaters, or mesh endpoints using short-range wireless communication technology.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A communication system for a frequency management system, the communication system comprising:
at least one positioning device configured to generate and broadcast location information;
one or more network devices configured to receive the location information from the at least one positioning device;
wherein the one or more network devices are configured to perform a frequency communication process with the frequency management system by using the received location information as current location information of the one or more network devices.

2. The communication system according to claim 1, wherein each of the at least one positioning device includes:
a processing circuit;
a positioning module configured to obtain the location information; and
a short-range wireless communication circuit controlled by the processing circuit for connecting to the one or more network devices, so as to broadcast the location information to the one or more network devices.

3. The communication system according to claim 2, wherein the location information includes latitude information, longitude information and altitude information.

4. The communication system according to claim 3, wherein the positioning device further includes an altimeter for obtaining the altitude information according to air pressure.

5. The communication system according to claim 2, wherein the frequency management system is an automated frequency coordination (AFC) system, the processing circuit is a global positioning system (GPS) module, and the short-range wireless communication circuit is a Bluetooth® communication circuit.

6. The communication system according to claim 2, wherein the processing circuit is configured to acquire the location information from the positioning module repeatedly, and control the short-range wireless communication circuit to periodically broadcast the location information to the one or more network devices according to a first predetermined time interval.

7. The communication system according to claim 6, wherein the positioning device is further configured to, in response to an installation mode being triggered, broadcast the location information within a second predetermined time interval, and the second predetermined time interval is shorter than the first predetermined time interval.

8. The communication system according to claim 2, wherein the processing circuit is further configured to encrypt the location information before the location information is broadcasted, and each of the one or more network devices is configured to decrypt the location information in response to receiving the location information.

9. The communication system according to claim 2, wherein the positioning device is further configured to broadcast a unique identifier along with the location information, and the one or more network devices are configured to perform the frequency communication process according to the unique identifier and the location information.

10. A communication method for a frequency management system, the communication method comprising:
generating and broadcasting location information by at least one positioning device;
receiving the location information and performing, by one or more network device, a frequency communication process with the frequency management system using the received location information as current location information of the one or more network devices.

11. The communication method according to claim 10, wherein each of the at least one positioning device includes:
a processing circuit;
a positioning module configured to obtain the location information; and
a short-range wireless communication circuit controlled by the processing circuit for connecting to the one or more network devices, so as to broadcast the location information to the one or more network devices.

12. The communication method according to claim 11, wherein the location information includes latitude information, longitude information and altitude information.

13. The communication method according to claim 12, wherein the positioning device further includes an altimeter for obtaining the altitude information according to air pressure.

14. The communication method according to claim 11, wherein the frequency management system is an automated frequency coordination (AFC) system, the processing circuit is a global positioning system (GPS) module, and the short-range wireless communication circuit is a Bluetooth® communication circuit.

15. The communication method according to claim 11, further comprising:
configuring the processing circuit to acquire the location information from the positioning module repeatedly, and control the short-range wireless communication circuit to periodically broadcast the location information to the one or more network devices according to a first predetermined time interval.

16. The communication method according to claim 15, further comprising:
configuring the positioning device to, in response to an installation mode being triggered, broadcast the location information within a second predetermined time interval, wherein the second predetermined time interval is shorter than the first predetermined time interval.

17. The communication method according to claim 11, further comprising:
encrypting, by the processing circuit, the location information before the location information is broadcasted; and
decrypting, by each of the one or more network devices, the location information in response to receiving the location information.

18. The communication method according to claim 11, further comprising:
broadcasting, by the positioning device, a unique identifier along with the location information; and
performing, by the one or more network devices, the frequency communication process according to the unique identifier and the location information.

19. A positioning device for a frequency management system, communicatively connecting to a communication system that includes one or more network devices, and the positioning device comprising:
a processing circuit;
a positioning module configured to obtain location information; and
a short-range wireless communication circuit controlled by the processing circuit for connecting to the one or more network devices, so as to broadcast the location information to the one or more network devices,
wherein the location information received by the one or more network devices are used to perform a frequency communication process with the frequency management system.

20. The positioning device according to claim 19, wherein the location information includes latitude information, longitude information and altitude information.
